(19) United States
(12) Patent Application Publication
(10) Pub. No.: US 2011/0191848 A1
(43) Pub. Date: Aug. 4, 2011

(54) PREVENTING MALICIOUS JUST-IN-TIME SPRAYING ATTACKS

(75) Inventors: Benjamin Goth Zorn, Woodinville, WA (US); Benjamin Livshits, Kirkland, WA (US); Reid Borsuk, Redmond, WA (US); John Joseph Lambert, Redmond, WA (US); Matthew Ryan Miller, Seattle, WA (US); Louis Lafreniere, Seattle, WA (US); Peter Stuart Beck, Prestbury (GB); Joshua Theodore Goodman, Bellevue, WA (US); Timothy William Burrell, Prestbury (GB); Steven Edward Lucco, Bellevue, WA (US)

(73) Assignee: Microsoft Corporation, Redmond, WA (US)

(21) Appl. No.: 12/699,073

(22) Filed: Feb. 3, 2010

(51) Int. Cl. G06F 11/00; G06F 9/45

(52) U.S. Cl. 726/22; 717/148

(57) ABSTRACT

A method disclosed herein includes acts of receiving code at a Just-in-Time compiler executing in an application on a computing device and compiling the code to generate machine code and causing the machine code to be placed on at least one page that is accessible by at least one processor on the computing device, wherein the Just-in-Time compiler compiles the code utilizing at least one technique for preventing a Just-in-Time spraying attack.

### BACKGROUND

Computing devices are often utilized to retain highly sensitive data. For example, many individuals retain personal financial data on their personal computing devices. Oftentimes, these computing devices are connected to a network such as the Internet. For instance, most personal computing devices are equipped with an Internet browser that can be utilized to access web pages. This connectivity of computing devices to networks can subject such computing devices to malicious attacks by hackers.

Even if a computing device does not include sensitive data, a hacker may still wish to access the computing device to utilize resources thereof. For example, a malicious hacker may provide malicious code to a computing device, wherein the code is configured, when executed by a processor on the computing device, to allow the hacker to control the computing device. The attacker may then utilize the processing capabilities of the computing device to perform a task desired by the hacker, which can affect performance of the computing device when utilized by the owner.

Generally, constructing an attack on a computing device consists of two parts: first the attacker must somehow place code on the computing device; and second, the code must be executed on the computing device. That is, machine code needs to be placed in an address space in memory corresponding to a program, and the program must jump to such code.

To combat such attacks, various techniques have been implemented. For example, some computing devices are equipped with an operating system that utilizes a technique referred to as data execution prevention. In this technique, a portion of the address space of a program, referred to as a heap, is associated with one or more bits that are set such that if code is attempted to be executed in the heap, the program takes an exception and fails to execute. Other techniques also exist for combating malicious attacks on computing devices.

### SUMMARY

The following is a brief summary of subject matter that is described in greater detail herein. This summary is not intended to be limiting as to the scope of the claims.

Described herein are various technologies pertaining to preventing and detecting malicious Just-in-Time (JIT) spraying attacks. JIT compilers are utilized in applications where compiling code at runtime of a program causes such program to execute more efficiently than, for example, interpreting the code or receiving precompiled code. For instance, many Internet browsers comprise JIT compilers that compile script code at execution time. An example of such script code is JavaScript®. Since JIT compilers are configured to compile code that is to be executed, programs, such as browsers, that utilize JIT compilers may be subject to malicious attacks.

Specifically, an attacker may generate malicious code and have such code transmitted to a JIT compiler (e.g., as source code or some intermediate code such as bytecode). The JIT compiler may compile such code to machine code (also referred to as native code) and place such code on a page in virtual memory to be executed by a processor. If the processor is caused to execute the malicious code (e.g., an application jumps to the location of the malicious code), the attacker may, for example, take control of the machine that is executing the application, thereby getting access to sensitive data stored on the machine. In one example, such malicious attack may be in the form of a spraying attack, where the malicious attacker causes multiple copies of the malicious code to be compiled and placed in the address space of the application that includes the JIT compiler.

Described herein are various techniques to mitigate/prevent and/or detect such attacks directed towards a computing device by way of a JIT compiler. For example, the attacker may craft an attack such that code includes injected data, which can refer to constants in the code. When these constants are compiled and placed in a particular order by the JIT compiler, such constants may form a portion of malicious code that, when executed by a processor, causes a malicious attack to be undertaken. To mitigate such attacks, the JIT compiler can be configured with one or more techniques to prevent/mitigate JIT spraying attacks. For example, the JIT compiler can be configured to randomly place constants across various pages of virtual memory that correspond to an application. Thus, for any two compilations of substantially similar code, constants can be placed in different locations and/or in different orders. Therefore, the malicious attacker cannot predict which order the constants will be placed in, and thus cannot guarantee that the resulting constants or order of constants when executed by a processor will result in a malicious attack.

In another example, the JIT compiler can be configured to cause all constants to be placed on non-executable pages of virtual memory. That is, the JIT compiler can cause constant data to be placed on non-executable pages, wherein the constant data is accessible by way of pointers, such that there is no mixture of executable code and constants on a same page. In still yet another example, the JIT compiler can be configured to surround constants on an executable page with halt instructions or other data that can cause an application attempting to execute such constants to output an error or crash. In another example, the JIT compiler can be configured to encode or encrypt constant through utilization of an encoding or encryption algorithm, such as an XOR function or other similar encoding or encryption algorithm. For instance, prior to the JIT compiler compiling a particular function or entire portion of code, the JIT compiler can be configured to randomly generate a particular value (e.g., a four-byte value), and such value can be used in connection with encrypting each constant. Each time the JIT compiler compiles code, the constant can be randomly generated. Accordingly, a malicious attacker cannot assume how constants will be compiled by the JIT compiler. Other techniques for mitigating attacks via a JIT compiler will be described herein.

Additionally described herein are various techniques for detecting malicious attacks attempted through utilization of a JIT compiler. Such techniques can be undertaken after the JIT compiler has compiled code to machine code and placed such code in one or more pages of virtual memory, but prior to such code being executed by a processor. In an example, a form of bytecode provided to the JIT compiler can be compiled into machine code, wherein the machine code comprises a plurality of functions. Each function can be analyzed to determine if something in such function appears to be “suspicious”. For example, a suspicious function may include numerous constants, may be relatively long, etc. A record of such functions that appear suspicious can be retained in memory, and if a set of executable pages includes a significant number of functions marked as suspicious, a flag can be raised to indicate that an attack is underway. For instance, the JIT compiler can be disabled upon detecting a substantially large number of suspicious functions. In another example, size or amount of code compiled by the JIT compiler can be analyzed, and if such amount is over a threshold, a flag can be raised (e.g., and the JIT compiler may be disabled). In still yet another example, after a flag has been raised, more in-depth code analysis may be undertaken to determine if an attack is being undertaken by way of a JIT compiler. For example, code provided to the JIT compiler can be analyzed/interpreted. Of course, various types of code analysis can be undertaken in connection with detecting a malicious attack desirably generated through a JIT compiler.

Other aspects will be appreciated upon reading and understanding the attached figures and description.

### BRIEF DESCRIPTION OF THE DRAWINGS

FIG. 1 is a functional block diagram of an example system that facilitates preventing JIT spraying attacks.

FIG. 2 is a functional block diagram of an example system that facilitates detecting JIT spraying attacks.

FIG. 3 is a flow diagram that illustrates an example methodology for preventing JIT spraying attacks.

FIG. 4 is a flow diagram that illustrates an example methodology that facilitates preventing JIT spraying attacks.

FIG. 5 is an example computing system.

### DETAILED DESCRIPTION

Various technologies pertaining to preventing and/or detecting Just-in-Time (JIT) spraying attacks will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

To provide context for one or more aspects described herein, a JIT spraying attack will now be described. Often, code produced by a JIT compiler is intended to be “safe” code, e.g. code that can be run from an untrusted source (e.g., an untrusted web page). However, in some cases, an attacker can find a way to move execution to start at a random or known position in memory, for instance, through various buffer overflow and/or dangling pointer attacks. When executing code from an untrusted source, however, a JIT compiler will not output code that is unsafe (code that could damage or compromise a machine), so such attacks are difficult.

One technique that attackers use is called “data spraying.” The contents of a memory in a computing device are typically of two different types: executable code and data. The data contents (e.g., text) are determined by the executing program, even when that program is untrusted. In some conventional implementations, an attacker can store malicious program instructions, disguised as data or text, in the data portion of memory. Then, by finding a way to cause execution to jump to a random or known location in memory, an attacker can cause this malicious code to execute. In order to mitigate against such attacks, a technique known as Address Space Layout Randomization (ASLR) is now often deployed, in which the location of data and code is moved at random for different executions. This makes jumping to a known location of less value, since it is difficult to place malicious code at that address.

In order to counteract ASLR, attackers may use “spraying” techniques, in which a large amount of data is placed in memory, perhaps nearly filling available memory. This data contains malicious code, disguised as data. Now, when a buffer overrun or other exploit is used, the attacker cannot predict where exactly his code will execute, but with moderate probability it will be one of the copies of the malicious code disguised as data.

To prevent these data spraying attacks, data pages may be marked as non-executable (“NX”). Most modern CPUs contain mechanisms to perform such marking, and will refuse to execute code on pages that are marked as non-executable. This makes it difficult to disguise code as data, since the code will reside on pages that are marked as non-executable, and an attack which jumps execution to one of these pages will fail. Typically, such an attempt will cause a process to fail, and be terminated, but no damage or compromise of the system can be achieved.

An additional, heretofore undiscovered attack can leverage a JIT compiler. A JIT compiler receives code in a certain format (e.g. source code or some intermediate form of code such as bytecode), and outputs machine language instructions. If the code is received from an untrusted source, the JIT compiler will only output safe instructions, e.g. those that can display information, but not those that can compromise a machine.

However, on some processors, a variety of machine instructions include both code and a very small amount of data adjacent to each other. For instance, on one example processor, there is an instruction of the following form:

mov dword ptr[ebp],CONST

where CONST is a constant. This constant is only typically 4 bytes long, and is stored on an executable page. Those 4 bytes, in combination with other tricks and other data that follows, are enough to encode the start of an attack. Although technically the constant is data, it is stored on a page that is marked as executable, since the data is part of an instruction. By generating a large number of such codes (“JIT Spraying”), and combining with another program flaw (e.g. a buffer overrun) an attacker may defeat both ASLR and no-execute mitigation techniques.

In summary, a JIT spraying attack occurs when a malicious hacker provides code to a JIT compiler, which is configured to compile such code at execution time. Generally, the malicious hacker attempts to predict how the JIT compiler will compile code provided thereto, and therefore attempts to cause machine code generated by the JIT compiler to include a malicious payload. In an example, the code provided to the JIT compiler can be source code, bytecode, or some other intermediate code that is translated by the JIT compiler into machine code. The attacker will generally wish to have multiple copies of the malicious payload to be placed on several executable pages to increase the likelihood that the attack will succeed (e.g., to increase the likelihood that an application will jump to an executable page that includes the malicious payload(s)). If a processor executes malicious machine code on an executable page, then, for example, the attacker can gain control of the computing device that includes the processor and gain access to data thereon or utilize resources of such computing device.

To provide additional context with respect to aspects described herein, different types of JIT spraying attacks will now be described. A first type of JIT spraying attack can be referred to as an injected data attack. To perform any type of JIT spraying attack, the attacker must control content of executable pages that a runtime system JIT compiler creates, wherein such pages are intended to include executable machine code. Such machine code is generated programmatically by the JIT compiler from the code provided by the attacker (source code, bytecode, etc.). Typically, code generated by the JIT compiler will be incapable of executing malicious operations, because if the compiler is bug free, it will perform a correct translation from a type safe language (such as JavaScript® or C#) to native machine code. Thus, to effectively generate a malicious attack on a computing device, the attacker can insert data into the source code that the JIT compiler thinks is source data (constants), when in fact such data is malicious code. Specifically, the attacker can construct a series of constants that the runtime system will place on the aforementioned executable pages. When such constants are executed by a processor, however, they act as a malicious function in machine code.

A second type of JIT spraying attack can be referred to as a misaligned code attack. Again, the attacker can have some knowledge of how the JIT compiler will translate the source code (or intermediate code) to machine code. To generate a misaligned code attack, the attacker can rely on the JIT compiler to produce a byte sequence in machine code that, when executed by a processor at an appropriate starting address, executes as a normal non-malicious portion of code, but when executed at some offset, executes a different, malicious, set of instructions.

A third type of JIT spraying attack can be referred to as a jump-past-prologue attack. In such an attack, the attacker can set up the code received by the JIT compiler to be compiled in such a way that an application jumps into a certain part of code, such that a security check is bypassed.

These are but three example types of JIT spraying attacks that can be implemented by a malicious entity, and are only provided for the sake of context and are not intended to limit the JIT spraying attack preventative and detection techniques described below.

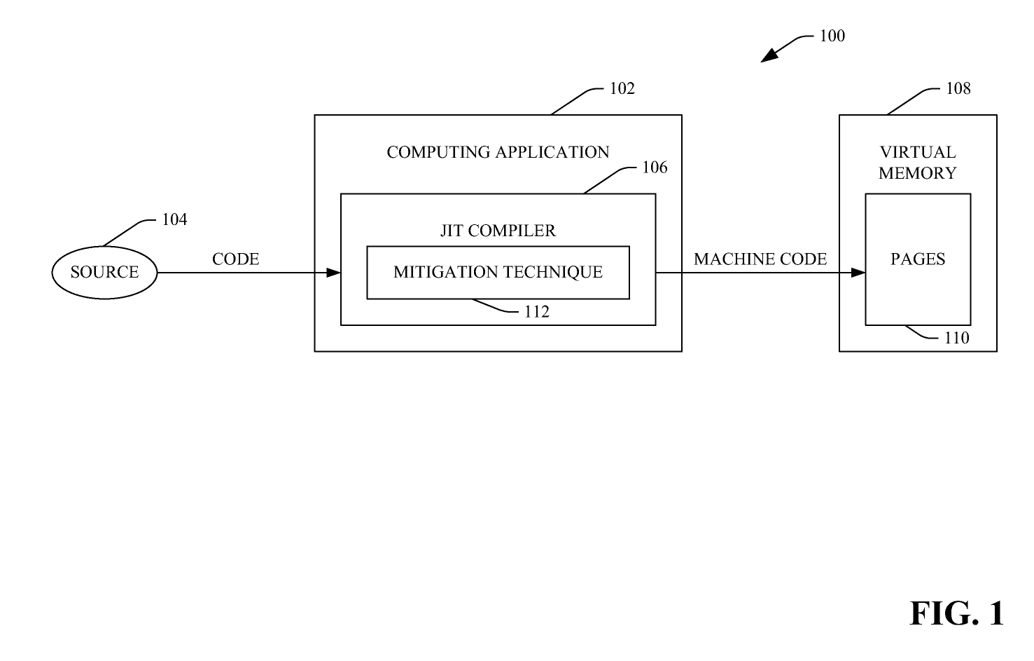

With reference now to FIG. 1, an example system 100 that facilitates preventing JIT spraying attacks is illustrated. The system 100 comprises a computing application 102 that is executing on a computing device (not shown). In an example, the computing application 102 may be an Internet browser. In another example, the computing application 102 may be a word processing application, a spreadsheet application, an image viewing application, or other suitable computing application. The computing application 102 may be in communication with a source 104 that provides the computing application 102 with code that is executable by a processor on the computing device. In an example, the source 104 may be a web server that provides script code (such as JavaScript®) to be executed by an Internet browser. It is to be understood, however, that the source 104 may be any suitable source of code.

The code provided by the source 104 may be source code or some form of intermediate code such as bytecode. The code provided by the source 104, then, is code that is intended to be compiled at runtime of the computing application 102. Thus, the computing application 102 comprises a JIT compiler 106 that receives the code from the source 104 and compiles such code to machine code.

A virtual memory 108 with an address space corresponding to the computing application 102 can comprise a plurality of pages 110, and the JIT compiler 106 can cause the machine code to be placed on one or more of the pages 110 that correspond to the address space of the computing application 102. While the computing application 102 is shown to have an address space in the virtual memory 108, it is to be understood that the computing application 102 may have an address space in physical memory such that virtual memory is not used.

When compiling the code received from the source 104, the JIT compiler 106 can utilize at least one JIT spraying attack mitigation technique 112. Thus, if the code provided by the source 104 comprises a JIT spraying attack, when a processor executes the JITed code (code compiled by the JIT compiler) on the at least one page in the virtual memory 108, such malicious code will not be executed, and the JIT spraying attack will be thwarted. Various example mitigation techniques that are intended to fall under the scope of the hereto-appended claims will now be described.

In an example, the at least one mitigation technique 112 utilized by the JIT compiler 106 may be configured to prevent injected data attacks from the source 104. As indicated above, an injected data attack refers to when an attacker selectively places constants in code provided to the JIT compiler 106 such that the JIT compiler will place the constants in a particular order in machine code. When executed by a processor, the constants act as malicious code.

In a first example, the JIT compiler 106 can be configured to place constants in JITed code onto non-executable pages in the virtual memory 108. Therefore, a processor would not be able to execute malicious code that is generated through utilization of injected data, since JITed constants are placed on non-executable pages in the virtual memory 108.

In another example, the mitigation technique 112 utilized by the JIT compiler 106 to prevent JIT spraying attacks can comprise randomizing locations of constants amongst a plurality of pages in the virtual memory 108. As indicated above, a malicious attacker bases an injected data attack on a presumption that the attacker knows how the JIT compiler 106 will place such constants on pages in the virtual memory 108. To thwart such attack, then, the JIT compiler 106 can have control over where constants are placed in the virtual memory 108, and can randomized their locations to render it difficult for an attacker to predict where the constants will reside in the virtual memory 108. Therefore, for two different compilations of the same code, the JIT compiler 106 can be configured to place constants in different locations in the virtual memory 108. An end result of randomizing location of constants in the virtual memory 108 is that, if the constants were placed by an attacker to generate a malicious attack, the resulting machine code becomes non-executable.

In yet another example, the mitigation technique 112 utilized by the JIT compiler 106 to prevent JIT spraying attacks can comprise selectively placing additional bytes of data onto one or more of the executable pages 110 in addition to bytes that represent the native machine code output by the JIT compiler 106. If such bytes are carefully chosen, then a processor, when attempting to execute malicious code will execute such additional bytes, and executing these bytes will cause the computing application 102 to crash or a particular process to halt. In another example, the additional bytes can be chosen to cause an exception when executed by a processor, wherein such exception can be handled by additional components that are intended to detect possible JIT spraying attacks. In an example, these additional bytes referred to above can be halt instructions or non-instruction data.

In yet another example, the mitigation technique 112 utilized by the JIT compiler 106 can comprise encoding data (constants) that are to be stored on executable pages in the virtual memory 108. Specifically, the JIT compiler 106 can utilize some form of random encoding/encryption when causing constants to be stored on the pages 110 in the virtual memory 108. Thus, instead of storing constants “in the clear,” the JIT compiler 106 can encrypt such constants with an encoding technique such as XORing constants with a dynamically generated random value that makes such constants different on each compilation by the JIT compiler 106, and thus will be difficult for a malicious attacker to predict. Again, this mitigation technique can negate an assumption of a malicious attacker of how the JIT compiler 106 will compile the code provided from the source 104.

Furthermore, the at least one mitigation technique 112 may be employed in connection with preventing a misaligned code attack. For instance, the mitigation technique 112 utilized by the JIT compiler 106 can comprise compiling the code received from the source 104 such that resulting instruction sequences in the machine code are generated randomly. For example, there can be many different manners to obtain the substantially similar effect for a given portion of source code. Different registers can be utilized, different instructions can be employed, instructions can be added that are essentially meaningless, etc. Thus, again, the JIT compiler 106 can randomly generate different sequences to prevent machine code generated by the JIT compiler 106 from being predictable.

In another example, a mitigation technique 112 utilized by the JIT compiler 106 can comprise randomly placing portions of the machine code on various of the pages 110 in the virtual memory 108. Specifically, the layout of the machine code, including the direction of loops, relative location of functions, etc., can be determined by the JIT compiler 106. Adding some nondeterminism to such decisions of the JIT compiler 106 can make generating an effective JIT spraying attack difficult.

In yet another example, the mitigation technique 112 utilized by the JIT compiler 106 can comprise placing halt instructions or non-instructions in the machine code when placed on the pages 110 of the virtual memory 108. For instance, the JIT compiler 106 can place halt instructions on code paths that are not intended to execute, such that if a processor were to jump into such code path randomly, an error would be generated, and the computing application 102 would cease to operate. Thus, the JIT compiler 106 can place targets of jumps in the machine code at different offsets, and can introduce arbitrary bytes of data in places that are not occupied by code intended to be executed. These targets (bytes) can be populated with values that can cause a malicious JIT spraying attack to fail.

In still yet another example, the mitigation technique 112 employed by the JIT compiler 106 can comprise spreading code for relatively large functions in unpredictable ways across the multiple pages in the virtual memory 108. For a JIT spraying attack to succeed, the attacker must have enough of the malicious code on executable pages to be probabilistically effective. Specifically, the attacker typically must encode both an NOP sled (a sequence of non-operation instructions) and shellcode into the malicious code. The larger the ratio of the NOP sled to the shellcode, the more likely an attack will succeed. As a result, the attacker benefits from injecting large amounts of code with known alignment and placement, which means that the attacker benefits from providing large functions to the JIT compiler 106. Spreading code for such large functions across multiple pages reduces the ratio of the NOP sled to the shell code, and thus reduces the likelihood that an attack will succeed. In one exemplary manner for spreading code across multiple pages, one or more pages in the virtual memory 108 can be marked as nonexecutable. Therefore, if the processor jumps to a nonexecutable page, the attack will fail. Placement of nonexecutable pages among executable pages in the virtual memory 108 can be undertaken randomly by the JIT compiler 106, thereby negating any assumption that the attacker may have pertaining to how the JIT compiler 106 will compile the code from the source 104 to the machine code.

In still yet another example, the mitigation technique 112 employed by the JIT compiler 106 can comprise encoding the machine code such that the machine code is encrypted on at least one of the executable pages 110 in the virtual memory 108 until just before such machine code is executed by a processor. Just as constants can be encoded and decoded when read, the machine code can be written by the JIT compiler 106 in such a way that the machine code is encoded on executable pages in the virtual memory 108 until just prior to the machine code being executed by a processor. The JIT compiler 106 can create a decode loop as a prologue that executes before executing any remainder of the machine code. This prologue can be employed to decode any remaining machine code instructions prior to such instructions being executed. This can prevent the attacker from being able to predict what the machine code will include, because the encryption can be undertaken with a new random value for each compilation.

In still yet another example, the mitigation technique 112 utilized by the JIT compiler 106 can comprise causing pages to be labeled as non-writeable as soon as code in such pages is executed by a processor. That is, after the JIT compiler 106 has placed machine code on a page in the virtual memory 108, the JIT compiler 106 can label the page as read only. This can prevent a class of attacks where an attacker gets a portion of code to execute, and uses that portion of code to write additional code into place (self-modifying code). Making the page read-only will cause an attack to fail, because such page would not be writeable by the self-modifying code. In an example, the JIT compiler 106 can indicate that only a single page in the virtual memory 108 for the computing application 102 is writeable at one point in time (the one page currently being written to), and when the JIT compiler 106 finishes writing to such page, can mark the page as read-only and mark a subsequent page as being writeable.

In still yet another example, the mitigation technique 112 utilized by the JIT compiler 106 can comprise pre-computing a well-defined function (such as a standard CRC/hash computation optionally seeded with some salt or secret) over portions of data being written to the virtual memory 108. The computing application 102 can then repeat the computation of the well-defined function and compare the result with the pre-computed result stored in the virtual memory 108. In particular, such a check may be carried out immediately after a page that has been temporarily writeable is marked read-only to ensure that the attacker has not taken advantage of the small window of opportunity where a page was writeable to corrupt contents thereof.

Furthermore, the computing application 102 itself can employ one or more mitigation techniques to prevent a JIT spraying attack. For example, the computing application 102 may be an Internet browser, which can have some knowledge of when code intended for the JIT compiler 106 is needed for execution. If the computing application 102 is not in the process of executing code generated by the JIT compiler 106, pages can be marked as non-executable, such that the computing application 102 is not doing any legitimate execution of code generated by the JIT compiler 106 (including malicious code).

Still further, the mitigation technique 112 utilized by the JIT compiler 106 can comprise limiting a number of pages that comprise machine code from the JIT compiler 106 to some threshold number of pages. Thus, once the JIT compiler 106 writes machine code to the threshold number of pages in the virtual memory 108, the JIT compiler 106 can be turned off (and interpreters can be used for any remaining code). Of course, other heuristics can be utilized in connection with disabling the JIT compiler. For example, a number of parameters passed to a function can be reviewed, and if such number is above a threshold the JIT compiler 106 can be disabled. In another example, if size of a function if larger than a threshold size the JIT compiler 106 can be disabled. In yet another example, if a certain sequence of instructions is repeated with frequency above a threshold frequency the JIT compiler 106 can be disabled. These and other conditions can be analyzed and utilized to disable the JIT compiler 106 if desired.

The mitigation technique 112 utilized by the JIT compiler 106 can comprise disabling the JIT compiler 106 with respect to dynamically generated or evaluated code. Some script languages can be utilized to generate new code and compile such code at runtime. Thus, the JIT compiler 106 can be disabled for dynamically generated code.

Moreover, the mitigation technique 112 utilized by the JIT compiler 106 can be employed to prevent a jump-past-prologue JIT spraying attack. For example, the mitigation technique 112 utilized by the JIT compiler 106 can include double checking before any security action is undertaken. Specifically, the JIT compiler 106 can anticipate an attack and can generate code such that before the JIT compiler 106 performs any security action (such as checking if the user is authorized), it can double check that the prologue code has executed. As indicated above, a prologue is used to ensure that code is entered into at an appropriate place (the prologue code is executed prior to some other portion of code being executed). The JIT compiler 106 can double check that the prologue has in fact been executed prior to performing a security action.

In another example, the mitigation technique 112 utilized by the JIT compiler 106 can comprise using control flow integrity to ensure that jumps in the code land in places that are expected at runtime. A form of control flow integrity can be implemented to ensure that if control has reached a certain point, the program is guaranteed to come from a particular location to get there. This can be analogous to someone leaving bread crumbs to indicate where they have been.

In another example, the mitigation technique 112 utilized by the JIT compiler 106 can comprise inserting many non-executable pages between the executable pages 110 in the virtual memory 108. This mitigation defeats the spraying attack by decreasing the likelihood that a random jump into virtual memory 108 will land on an executable page containing machine code generated by the JIT as part of the spraying attack.

While a variety of techniques have been described above for preventing certain types of JIT spraying attacks, it is to be understood that, over time attackers may become more sophisticated and develop new types of attacks through the JIT compiler 106. The claims below are intended to cover any types of JIT spraying attacks, as well as any type of mitigation technique utilized to mitigate such JIT spraying attacks.

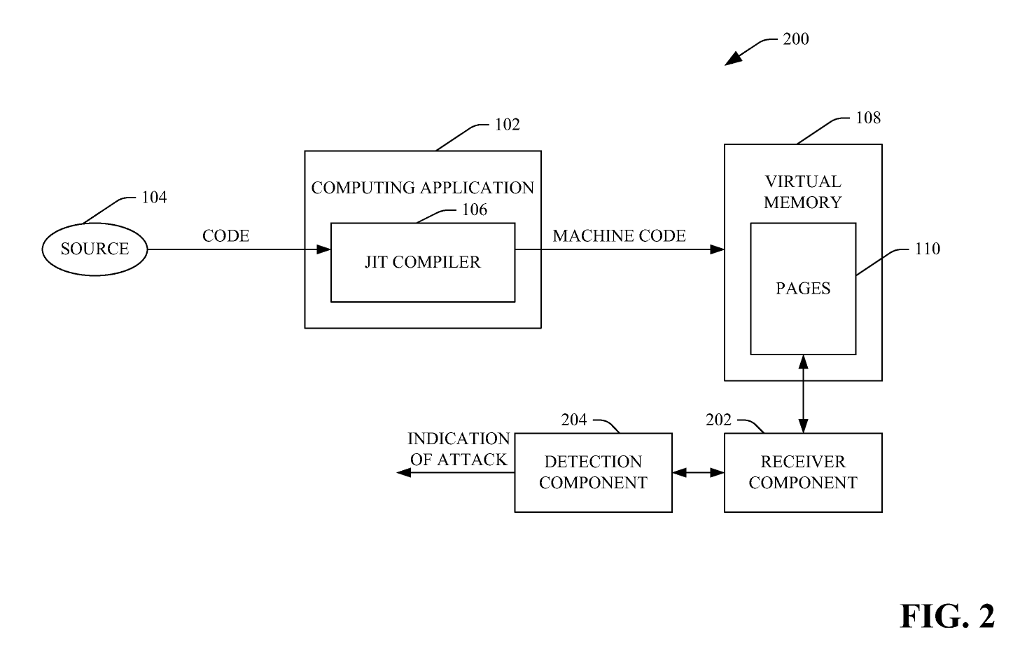

With reference now to FIG. 2, an example system 200 that facilitates detecting JIT spraying attacks is illustrated. The system 200 comprises the computing application 102 that is executing on a computing device. The computing application 102 comprises the JIT compiler 106 that receives code from the source 104 and compiles such code at runtime of the computing application 102. The compiled code (machine code) is placed in the pages 110 of the virtual memory 108.

The system 200 further comprises a receiver component 202 that receives the machine code compiled by the just-in-time compiler 106 and placed on the pages 110 of the virtual memory 108. A detection component 204 is in communication with the receiver component 202, and is configured to execute at least one JIT spraying attack detection technique prior to a processor executing the machine code in the virtual memory 108. In contrast to the JIT spraying attack prevention techniques described above, which can cause a JIT spraying attack to fail, the system 200 is utilized to detect JIT spraying attacks, thereby allowing an individual or program to reconstruct a manner in which the attack took place. Thus, it may be possible to learn more about the nature of the attack, if such attack is detected in progress.

An example detection technique that can be utilized by the detection component 204 comprises comparing size of a function in the machine code generated by the JIT compiler 106 with a threshold size, and setting at least one bit to indicate that further analysis is desirable if the size of the function in the machine code is greater than the threshold size. As discussed previously, a malicious attacker can benefit from providing a larger function to the JIT compiler 106 for compilation. In an example, most JavaScript® functions are relatively small, and thus it is relatively rare to see large functions whose machine code output by the JIT compiler 106 would occupy numerous pages.

Another example technique for detecting JIT spraying attacks that can be utilized by the detection component 204 can comprise comparing a total number of bytes of machine code generated by the JIT compiler 106 with a threshold number of bytes. If the number of bytes of machine code is greater than the threshold, then the detection component 204 can be configured to output some indication that further analysis is desired. In another example, the detection component can be configured to transmit a message to the JIT compiler 106 to cease operation. In such a case, an interpreter can be utilized to interpret code intended for the JIT compiler 106.

In still another example, a detection technique utilized by the detection component 204 to detect a JIT spraying attack can comprise comparing a number of functions in the machine code output by the JIT compiler 106 responsive to receipt of the code from the source 104 with some threshold number, and thereafter performing some action to indicate that further analysis is to be undertaken if the number of functions in the machine code is greater than the threshold number. For example, a particular bit in a register can be set to indicate that further analysis is desired.

In yet another example, a detection technique utilized by the detection component 204 in connection with detecting a JIT spraying attack can comprise searching the machine code output by the JIT compiler 106 responsive to receipt of the code from the source 104 for at least one pattern that is indicative of a JIT spraying attack. The detection component 204 may then output data that indicates that further analysis needs to be undertaken if the at least one pattern is found in the machine code. For example, the detection component 204 can search for a certain number of branches, constants, etc., that may be used by a malicious attacker to trick the JIT compiler 106 into generating malicious code. Detection of such patterns may desirably trigger more detailed analysis or, for instance, disabling the JIT compiler 106.

If the detection component 204 outputs a trigger that indicates a JIT spraying attack has been attempted, then various responses can be initiated by the detection component 204. For example, a code analysis tool can be executed to more precisely detect suspicious code patterns. A particular code analysis tool is described in detail in the following article: Ratanaworabhan, et al. “Nozzle: A Defense Against Heat-Spraying Code Injection Attacks”, USENIX Security Symposium, August 2009, the entirety of which is incorporated herein by reference. The code analysis tool is also described in U.S. patent application Ser. No. 12/369,018, filed on Feb. 11, 2009, and entitled “Monitoring System for Heap Spraying Attacks,” the entirety of which is incorporated herein by reference. Such a code analysis tool can be utilized to detect JIT spraying attacks by searching the machine code generated by the JIT compiler 106 and determining if such code, when entered at different offsets, has execution characteristics that are unlikely to occur randomly. For example, the code analysis tool can be configured to review the code to ascertain what a result would be if such code were interpreted, and thereafter executing such code at an offset different from what was intended by the JIT compiler 106. For instance, “garbage” may be seen if the code output by the JIT compiler 106 were executed at some different point. In another example, streams of bytes may merge with original executed code such that it can be ascertained that executing the code at the offset will result in executing the same code as desired by the JIT compiler 106. In still yet another example, instructions that are entirely different from the original code may be ascertained, in which case it is probable that a JIT spraying attack has occurred.

In another example, a statistical analysis of executable pages can be undertaken to more precisely search for suspicious patterns in the machine code stored thereon. For instance, an encoded spraying attack can require that a decode loop is present at the same offset in multiple executable pages. Such a repetition is unlikely to occur accidentally in nonmalicious executable pages.

In yet another example, if the detection component 204 determines that further analysis is desired, offset sequences can be searched for that do not merge into the main execution sequence after a short sequence. It can be assumed that the attacker cannot use machine code output by the JIT compiler 106 to implement the attack, because the code output by the JIT compiler 106 will not execute instructions that would typically be executed by shellcode. Thus, the attacker must embed another sequence of instructions in the code output by the JIT compiler 106, which sequence implements an NOP sled and shell code. Having a large quantity of different instructions when decoding starting at a different offset may be an unusual property for benign code, and may indicate the nature of a JIT spraying attack.

In still yet another example, different memory offsets of the executable code can be emulated to locate long paths in such code. Executable code generated by the JIT compiler 106 will typically not include embedded subsequences that are themselves long sequences of executable instructions. If such embedded subsequences are located, it may be probable that a JIT spraying attack has occurred.

It is to be understood that aspects described in FIG. 1 can be utilized in combination with aspects described in FIG. 2. For example, initially the JIT compiler 106 may be configured to not employ one or more of the JIT spraying attack prevention techniques discussed above, since one or more of such techniques may have some computational costs associated therewith that may affect performance of the computing application 102. However, one or more of the detection techniques can be utilized, and if a trigger is output by the detection component 204, the JIT compiler 106 can be configured to utilize one or more of the JIT spraying attack mitigation techniques thereafter. Additionally or alternatively, in some instances it may be desirable to tolerate an attempted JIT spraying attack. For instance, detection techniques may detect false positives, in which case taking aggressive action such as killing a process may create an unpleasant user experience. In another example, a JIT spraying attack may be tolerated if killing the process is less desirable than tolerating the attack. For example, if a JIT spraying attack is detected, the JIT compiler 106 can be completely disabled. Disabling the JIT compiler 106 may result in a decrease in application performance, but without the JIT compiler 106 generating machine code, the attack vector is entirely prevented.

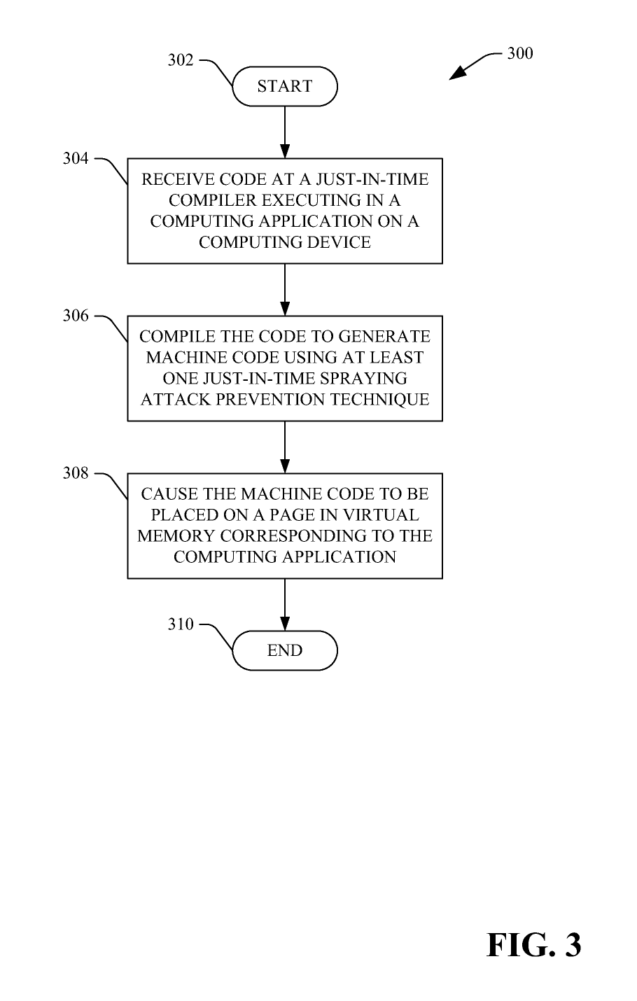

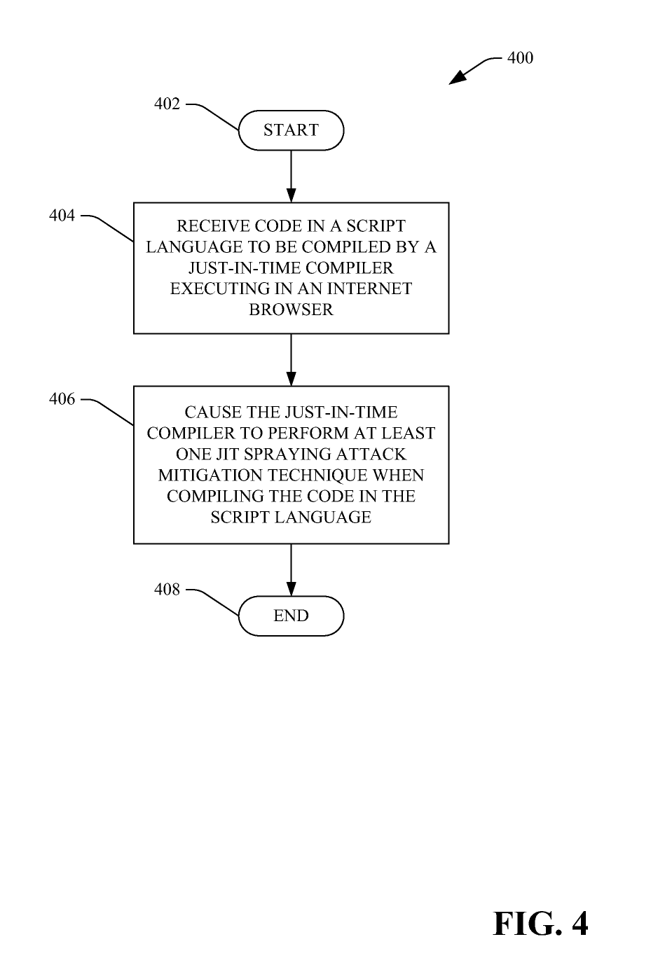

With reference now to FIGS. 3 and 4, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring now to FIG. 3, a methodology 300 that facilitates preventing a JIT spraying attack is illustrated. The methodology 300 begins at 302, and at 304 code is received at a JIT compiler executing in a computing application on a computing device. For example, the computing device may be a personal computer, a portable computing device such as a mobile telephone, etc.

At 306, the code received at 304 is compiled to generate machine code, using at least one just-in-time spraying attack prevention technique. Example techniques have been described above with respect to FIG. 1.

At 308, the machine code is caused to be placed on a page in virtual memory corresponding to the computing application, wherein such machine code may be executed by a processor. The methodology 300 then completes at 310.

Referring now to FIG. 4, an example methodology 400 that facilitates mitigating a JIT spraying attack is illustrated. The methodology 400 starts at 402 and at 404 script code, such as JavaScript® code, to be compiled by a JIT compiler executing in an Internet browser is received. For example, a processor can execute code that causes the Internet browser to be executing on a computing device.

At 406, the JIT compiler is caused to perform at least one mitigation technique for preventing a just-in-time spraying attack when the just-in-time compiler compiles the script code. Again, these mitigation techniques have been described above with reference to FIG. 1. The methodology 400 completes at 408.

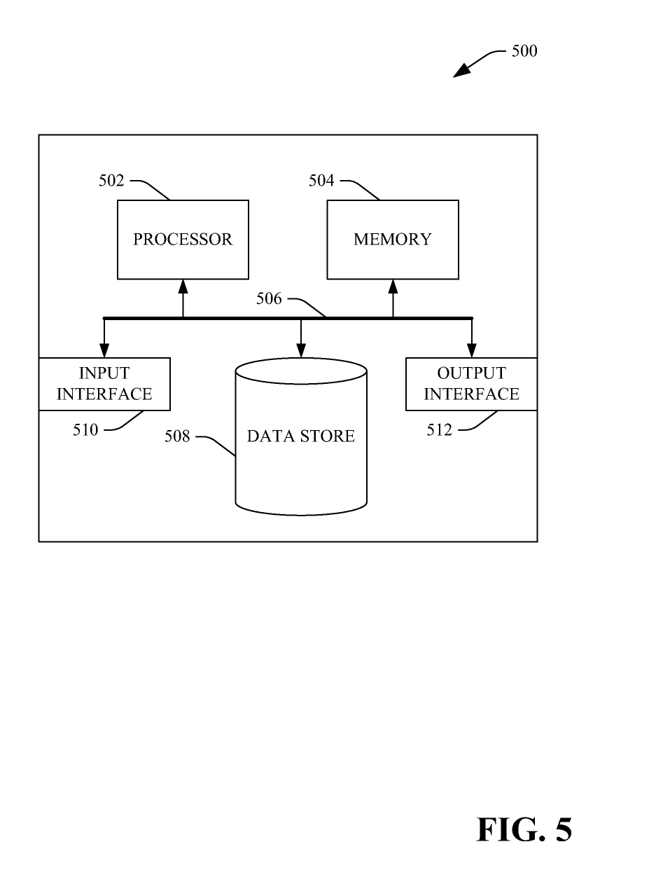

Now referring to FIG. 5, a high illustration of an example computing device 500 that can be used in accordance with the systems and methodologies disclosed herein is illustrated. For instance, the computing device 500 may be used in a system that supports preventing JIT spraying attacks. In another example, at least a portion of the computing device 500 may be used in a system that supports detecting JIT spraying attacks. The computing device 500 includes at least one processor 502 that executes instructions that are stored in a memory 504. The instructions may be, for instance, instructions for implementing functionality described as being carried out by one or more components discussed above or instructions for implementing one or more of the methods described above. The processor 502 may access the memory 504 by way of a system bus 506. In addition to storing executable instructions, the memory 504 may also store constants in source code, amongst other data.

The computing device 500 additionally includes a data store 508 that is accessible by the processor 502 by way of the system bus 506. The data store 508 may include executable instructions, constants, byte code, etc. The computing device 500 also includes an input interface 510 that allows external devices to communicate with the computing device 500. For instance, the input interface 510 may be used to receive instructions from an external computer device, from an individual, etc. The computing device 500 also includes an output interface 512 that interfaces the computing device 500 with one or more external devices. For example, the computing device 500 may display text, images, etc. by way of the output interface 512.

Additionally, while illustrated as a single system, it is to be understood that the computing device 500 may be a distributed system. Thus, for instance, several devices may be in communication by way of a network connection and may collectively perform tasks described as being performed by the computing device 500.

As used herein, the terms “component” and “system” are intended to encompass hardware, software, or a combination of hardware and software. Thus, for example, a system or component may be a process, a process executing on a processor, or a processor. Thus, a component may be a portion of memory that comprises instructions executable by a processor, a core of a multiprocessor unit, a series of transistors, etc. Additionally, a component or system may be localized on a single device or distributed across several devices.

Furthermore, as used herein, “computer-readable medium” is intended to refer to a non-transitory medium, such as memory, including RAM, ROM, EEPROM, Flash memory, a hard drive, a disk such as a DVD, CD, or other suitable disk, etc.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising the following computer-executable acts:
receiving code at a Just-in-Time compiler executing in an application on a computing device; and
compiling the code to generate machine code and causing the machine code to be placed on at least one page that is accessible by at least one processor on the computing device, wherein the Just-in-Time compiler compiles the code utilizing at least one technique for preventing a Just-in-Time spraying attack.

2. The method of claim 1, wherein the application on the computing device is an Internet browser, and wherein the code corresponds to a scripting language.

3. The method of claim 1, wherein the code comprises a plurality of constants, and wherein the at least one technique for preventing the Just-in-Time spraying attack comprises randomly distributing the constants in the machine code across a plurality of pages.

4. The method of claim 1, wherein the code comprises a plurality of constants, and wherein the at least one technique for preventing the Just-in-Time spraying attack comprises at least one of surrounding at least one constant with at least one of a halt instruction data or non-instruction data on the at least one page or embedding random data in the instruction data with instructions to jump over such random data.

5. The method of claim 1, wherein the code comprises a plurality of constants, and wherein the at least one technique for preventing the Just-in-Time spraying attack comprises encoding the constants in the machine code with an encoding or encryption algorithm.

6. The method of claim 1, wherein the code comprises a plurality of constants, and wherein the at least one technique for preventing the Just-in-Time spraying attack comprises causing at least one of the constants to be stored on a non-executable page.

7. The method of claim 1, wherein the at least one technique for preventing the Just-in-Time spraying attack comprises at least one of:
compiling the code such that resulting instruction sequences are generated randomly; or
disabling the JIT compiler if dynamically generated code is received by the JIT compiler.

8. The method of claim 1, wherein the at least one technique for preventing the Just-in-Time spraying attack comprises randomly laying out placement of the machine code, such that two compilations of the code would result in different placement of the machine code across virtual memory.

9. The method of claim 1, wherein the at least one technique for preventing the Just-in-Time spraying attack comprises placing halt instructions in portions of the at least one page that are not included in the code.

10. The method of claim 1, wherein the at least one technique for preventing the Just-in-Time spraying attack comprises marking at least one other page as non-executable.

11. The method of claim 1, wherein the at least one technique for preventing the Just-in-Time spraying attack comprises encoding the machine code such that the machine code is encoded or encrypted on the at least one executable page until the machine code is executed by the processor.

12. The method of claim 1, wherein the at least one technique for preventing the Just-in-Time spraying attack comprises causing the at least one page to be non-writable subsequent to the at least one page being written by the Just-in-Time compiler.

13. The method of claim 1, wherein the at least one technique for preventing the Just-in-Time spraying attack comprises:
comparing a condition pertaining to the code received by the Just-in-Time compiler with a predefined threshold; and
ceasing compilation of the code if the condition is above the predefined threshold.

14. A system that facilitates detecting a Just-in-Time spraying attack from a malicious entity that provides code to a Just-in-Time compiler, the system comprising the following computer-executable components:
a receiver component that receives machine code that has been compiled by the Just-in-Time compiler;
a detection component that is configured to execute at least one Just-in-Time attack detection technique prior to a processor executing the machine code.

15. The system of claim 14, wherein the code is in a script language, and wherein an Internet browser comprises the Just-in-Time compiler.

16. The system of claim 14, wherein the at least one Just-in-Time attack detection technique comprises:
comparing size of a function in the machine code with a threshold size; and
setting at least one bit to indicate that further analysis is to be undertaken if the size of the function in the machine code is greater than the threshold size.

17. The system of claim 14, wherein the at least one Just-in-Time attack detection technique comprises:
comparing a number of functions in the machine code with a threshold number; and
setting at least one bit to indicate that further analysis is to be undertaken if the number of functions in the machine code is greater than the threshold number.

18. The system of claim 14, wherein the at least one Just-in-Time attack detection technique comprises:
searching the machine code for at least one pattern that is indicative of a Just-in-Time spraying attack; and
setting at least one bit to indicate that further analysis is to be undertaken if the at least one pattern is found in the machine code.

19. The system of claim 14, wherein the at least one Just-in-Time attack detection technique comprises:
interpreting the code prior to the machine code being executed by the processor.

20. A computer-readable medium comprising instructions that, when executed by a processor, cause the processor to perform the following acts:
receiving code in a scripting language to be compiled by a Just-in-Time compiler executing in an Internet browser that is executed by the processor;
causing the Just-in-Time compiler to perform at least one mitigation technique for preventing a Just-in-Time spraying attack when the Just-in-Time compiler compiles the code in the scripting language.
